(19) United States
(12) Patent Application Publication
(10) Pub. No.: US 2016/0026377 A1
(43) Pub. Date: Jan. 28, 2016

(54) SYSTEM AND METHOD FOR COLLECTING, CURATING, AGGREGATING, AND DISPLAYING METRICS DATA FROM AND TO STAKEHOLDERS IN THE CHARITABLE SECTOR

(71) Applicant: POSIBA, INC., San Diego, CA (US)

(72) Inventors: Elizabeth S. Dreicer, San Diego, CA (US); Anders Olsson, San Diego, CA (US); Arnon Brouner, San Diego, CA (US); Samuel Scott Beckey, San Diego, CA (US); Petar P. Kralev, San Diego, CA (US)

(21) Appl. No.: 14/806,541

(22) Filed: Jul. 22, 2015

Related U.S. Application Data
(60) Provisional application No. 62/027,739, filed on Jul. 22, 2014.

(51) Int. Cl. G06F 3/0484; G06F 17/24

(52) U.S. Cl. CPC G06F 3/04847; G06F 17/246

(57) ABSTRACT

A system for analyzing data, comprising a metrics data system operating on a processor and configured to generate a user prompt that allows a user to interactively provide metrics data associated with an organization. A metrics display function system operating on the processor and configured to generate a user prompt that allows a user to interactively select or modify a display process that is to be applied to the metrics data. A metrics analytics function system operating on the processor and configured to generate a user prompt that allows a user to interactively select or modify a data analysis function that is to be applied to the metrics data.

### RELATED APPLICATIONS

The present application claims benefit of U.S. Provisional Patent Application No. 62/027,739, filed Jul. 22, 2014, which is hereby incorporated by reference for all purposes as if set forth herein in its entirety.

### TECHNICAL FIELD

The present disclosure relates generally to data management, and more specifically to a system of collecting, curating, aggregating, and displaying metrics data from and to all stakeholders in the charitable sector.

### BACKGROUND OF THE INVENTION

Intelligence about what is happening “on the ground” in the charitable sector currently lives in disparate locations, including excel files, organizational databases or websites and physical objects such as note-pads. As such, there is no centralized source for information about program scope or effectiveness. Experts and practitioners cannot effectively monitor and evaluate what works and what doesn't in timely and truly informed ways.

### SUMMARY OF THE INVENTION

A system for analyzing data is provided that includes a metrics data system operating on a processor and configured to generate a user prompt that allows a user to interactively provide metrics data associated with an organization. A metrics display function system operating on the processor and configured to generate a user prompt that allows a user to interactively select or modify a display process that is to be applied to the metrics data. A metrics analytics function system operating on the processor and configured to generate a user prompt that allows a user to interactively select or modify a data analysis function that is to be applied to the metrics data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for providing metrics collaboration functionality in accordance with an exemplary embodiment of the present disclosure;

FIG. 2 is a diagram of a system for providing metrics data in accordance with exemplary embodiment of the present disclosure;

FIG. 3 is a diagram of a system for providing metrics display functionality in accordance with an exemplary embodiment of the present disclosure;

FIG. 4 is a diagram of a system for providing metrics analytics functions capability in accordance with an exemplary embodiment of the present disclosure;

FIG. 5 is a diagram of an algorithm for providing user access to data sets, displays and data analysis functions, in accordance with an exemplary embodiment of the present disclosure;

FIG. 6 is a diagram of field metrics with associated system components; and

FIG. 7 is a diagram showing two dimensions (metrics and entities) of a multidimensional repository.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Current metrics databases can be categorically divided into two types. The first are those that are collected by government or other organizations and published for consumption to the broader public or by subscription. The difference between these solutions and the present disclosure is that the present disclosure is crowd-sourced, where metrics can be populated by any user at some levels. In addition, the present disclosure provides flexibility in accepting various metric formats and types, compared with existing metric databases that are highly specialized and rigid in their required formats.

The second metric database type includes those that outline metrics types and standards but do not actually collect or report any data. Unlike these tools (such as IRIS: http://iris.thegiin.org/metrics/list), the present disclosure can collect and store metrics data, in addition to cataloguing the types and definitions of the metrics themselves.

Field Metrics Examples:

1. Funders can ask/require their recipients to report (for evaluation purposes):
a. Foundation A can use the system to prepare a template for entering a metric or a collection of metrics.
b. Foundation A can then proceed to send this template to one or multiple organizations to fill out.
c. Each recipient of the template can upload the relevant metric data that is being requested through the said template.
d. Foundation A can evaluate the data from all respondents one-by-one or in the aggregate—comparing one with the peer group—using the reporting interface of the system.
2. Charities can use to showcase their performance to funders/donors or illustrate need (Providing a platform where charities can showcase their impact in a synthesized, results-oriented way, increasing their chances of being noticed/recognized):
a. Charity A can use the system to upload the latest data on meals served by their local office.
b. Charity A program officer can use the system to share the said metric with the Charities funders in the hopes of attracting increase in funding from current sources
c. In addition, the program office can share the metric broadly using the system, such that Charity A can be benchmarked against other similar charities in terms of operational performance.
3. Organizations can share internally (for board members and management decisions)
4. Funders can use metrics data for resource allocation decision making.
5. General research and evaluation purposes (consume content).
6. Experts, researchers, and individuals care about and want to contribute to common knowledge

A Field Metrics Module is one component of the larger disclosed system. The Field Metrics Module enables a one-stop solution for finding, uploading, commenting on, and editing charitable sector outcomes and metrics data. The Field Metrics Module is both a major database of publicly available metrics curated and organized in a highly sophisticated way across themes (areas of focus; e.g. education, health, etc.), geographies, and populations, and a tool that enables “crowd-sourcing” of metrics data through member participation.

The latter capability can be used by funders and government for a common reporting platform related to measurements from the field. In one embodiment, an “self-uploaded metrics” piece of the module can allow users to easily upload metrics data, create metrics templates and requests that others complete them (coupled with the ability to then analyze all responses in a cohesive way), explore and visually analyze the data, and share contributed metrics data with other organizations or broadly to the public.

The Field Metrics Module can further allow stakeholders to:

1. Assess which interventions work or don't work
2. Identify outliers, trends and needs on the ground
3. Forecast program performance over time, based on data from the recent past
4. Share their own measures and outcomes

The Field Metrics Module can be configured to depend on certain other components of the present disclosure to operate. The components include:

USERS: manages user authorization, authentication, roles and privileges as well as providing the external interface to the users themselves.

CATEGORIES: defines the taxonomy of social good and allows grouping of both entities and activities into those categories.

DICTIONARY: defines the tracked information that the present disclosure can obtain and seek to maintain about entities.

ENTITIES: the list of organizations and institutions that the present disclosure gathers, tracks, and maintains information about.

REPOSITORY: a database that contains information about entities in terms of the Dictionary.

COLLECTION: a grouping of Entities.

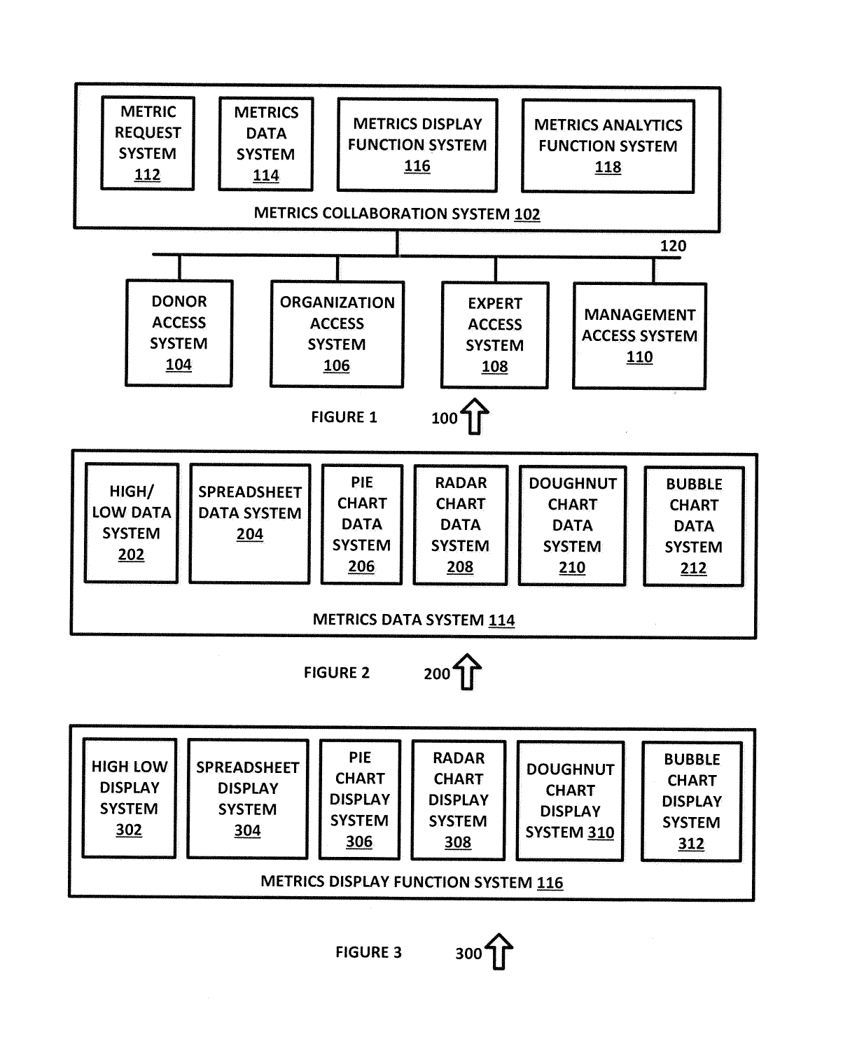

FIG. 1 is a diagram of a system 100 for providing metrics collaboration functionality in accordance with an exemplary embodiment of the present disclosure. System 100 includes metrics collaboration system 102, donor access system 104, organization access system 106, expert access system 108, management access system 110, metrics request system 112, metrics data system 114, metrics display function system 116, and metrics analytics function system 118, each of which can be implemented in hardware or a suitable combination of hardware and software, and which intercommunicate over network 120.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Metrics collaboration system 102 allows a plurality of users to collaborate on providing data, analyzing data and otherwise generating metrics for an organization. In one exemplary embodiment, an organization such as a business or charitable organization can have associated data, such as a number of employees, an amount of money received, an amount of volunteer hours received, a number of people served, a number of outcomes (e.g. medical operations, scholarships, meals) and other suitable data. Metrics can be generated using this data to help determine the effectiveness of the organization, such as a number of outcomes per employee, the cost of each outcome, and other suitable metrics. Likewise, metrics for different organizations can be compared to provide a competitive or comparative analysis, to aid in selecting the organization to donate money to or for other suitable purposes. Metrics collaboration system 102 allows different users to collaborate in this manner, such as donors, charitable organization employees, outside experts and managers, such as by assigning each user access to predetermined sets of data, predetermined data analytics functions and so forth.

Donor access system 104 can be implemented as one or more algorithms operating in conjunction with a web browser, a thin client application or other suitable systems operating on a laptop computer, a desktop computer, a tablet computer, a smart telephone, a handheld user device, or other suitable devices. Donor access system 104 allows a donor to access functionality of metrics collaboration system 102. In one exemplary embodiment, a user of donor access system 104 can be given authorization to access predetermined data sets, display functions, metrics analytics, or other suitable functionality of metrics collaboration system 102, can request data or metrics from other users, or can perform other suitable functions.

Organization access system 106 can be implemented as one or more algorithms operating in conjunction with a web browser, a thin client application or other suitable systems operating on a laptop computer, a desktop computer, a tablet computer, a smart telephone, a handheld user device, or other suitable devices. Organization access system 106 allows users at an organization to access metrics collaboration system 102, such as to review a request for data or metrics, to provide metrics data, to provide metrics display functions, to provide metrics analytics functions, or for other suitable purposes.

Expert access system 108 can be implemented as one or more algorithms operating in conjunction with a web browser, a thin client application or other suitable systems operating on a laptop computer, a desktop computer, a tablet computer, a smart telephone, a handheld user device, or other suitable devices. Expert access system 108 allows a third-party expert to access metrics collaboration system 102 to provide data or data analysis expertise for data display and data processing functions, such as in response to a request from a donor, an organization, and management system, or other suitable parties.

Management access system 110 can be implemented as one or more algorithms operating in conjunction with a web browser, a thin client application or other suitable systems operating on a laptop computer, a desktop computer, a tablet computer, a smart telephone, a handheld user device, or other suitable devices. Management access system 110 allows a management organization to access metrics collaboration system 102 and its associated data and functions, to configure access authorization levels for donor access system 104, organization access system 106, and expert access system 108, or to perform other suitable functions.

Metrics request system 112 can be implemented as one or more algorithms operating in conjunction with a web browser, a thin client application or other suitable systems operating on a laptop computer, a desktop computer, a tablet computer, a smart telephone, a handheld user device, or other suitable devices. Metrics request system 112 allows a user to request metrics that are not present, that are available through metrics collaboration system 102 or other suitable data. In one exemplary embodiment, a user can request metrics that were previously defined for an organization, such as to show a number of employees for organization, an amount of money spent by the organization for selected goods or services, the percentage of funds received that were spent on overhead, the percentage of funds received that were provided to recipients of aid, or other suitable data.

Metrics data system 114 stores metrics data for charitable organizations or other types of organizations. In one exemplary embodiment, metrics data system 114 can include predetermined file formats that are configured to receive data from one or more predetermined sources, can receive data in a file format having delimiters that comply with predetermined formatting rules or can receive, store and retrieve other suitable metrics data.

Metrics display function system 116 can be implemented as one or more algorithms operating in conjunction with a web browser, a thin client application or other suitable systems operating on a laptop computer, a desktop computer, a tablet computer, a smart telephone, a handheld user device, or other suitable devices. Metrics display function system 116 allows a user to select a display function for metrics, such as to divide a first data set by a second data set, to compare a plurality of data sets or to perform other suitable functions. In one exemplary embodiment, a user can elect to have metrics displayed as a spreadsheet, a pie chart, a radar chart, or in other suitable manners.

Metrics analytics function system 118 can be implemented as one or more algorithms operating in conjunction with a web browser, a thin client application or other suitable systems operating on a laptop computer, a desktop computer, a tablet computer, a smart telephone, a handheld user device, or other suitable devices. Metrics analytics function system 118 allows a user to select or define functions for analyzing metrics. In one exemplary embodiment, a user can determine a new metric for an organization based upon available data sets, such as a number of persons that received aid as a function of a population of available persons for receiving the aid. The user can access metrics analytics function system 118 and can select, store or modify data functions for generating metrics, and can perform other suitable functions.

Network 120 can be a wireline network, a wireless network, an optical network, a virtual network, other suitable networks or a suitable combination of networks.

In operation, system 100 allows users to access metrics that provide insight to the functioning of an organization, such as a charitable organization or other suitable organizations. In one exemplary embodiment, the user can be a donor that is looking for charitable organizations to donate money to. The donor can use system 100 to identify organizations having suitable performance analytics. In another exemplary embodiment, an organization can review data that identifies the organization's functions, and can determine whether suitable data exists to adequately and properly describe the organization's functions. In this exemplary embodiment, the organization can provide additional data, metrics or data analysis functions, so that such functions can be adequately analyzed by donors.

In another exemplary embodiment, a management organization can determine that additional data or data analysis functions are needed for organizations, donors, or other groups, and can request an expert to provide the data or data analysis functions. The experts can be provided with limited access to the system for the purpose of performing additional analysis of existing data, to provide data that has been obtained by the expert, or for others it will purposes.

FIG. 2 is a diagram of a system 200 for providing metrics data in accordance with exemplary embodiment of the present disclosure. System 200 includes metrics data system 114 and high/low data system 202, spreadsheet data system 204, pie chart data system 206, radar chart data system 208, donut chart data system 210 and bubble chart data system 212, each of which can be implemented in hardware or suitable accommodation or hardware and software.

High/low data system 202 provides and receives data sets in a high/low data set form. In one exemplary embodiment, high/low data system 202 can generate a user interface prompt for a user to enter data defining a range for a period of time, an opening data value, a minimum data value, a maximum data value, a closing date value and other suitable data. Likewise, other suitable sets of data can be received or provided in a high/low data format, such as in a file format, delimited fields in a digital document or in other suitable manners.

Spreadsheet data system 204 provides and receives data in a spreadsheet data format. In one exemplary embodiment, spreadsheet data system 204 can generate a user interface prompt for a user to enter column identifiers identifying a type of data in each column, corresponding data sets for each row, and other suitable data formats. Likewise, other suitable sets of data can be received or provided in a spreadsheet data format, such as in a file format, delimited fields in a digital document or in other suitable manners.

Pie chart data system 206 provides and receives data format suitable for use with a pie chart. In one exemplary embodiment, pie chart data system 206 can generate a user interface prompt for a user to enter a set of data for a pie chart, pie chart colors and characteristics, and other suitable data. Likewise, other suitable sets of data can be received or provided in a pie chart data format, such as in a file format, delimited fields in a digital document or in other suitable manners.

Radar chart data system 208 provides and receives data in a format suitable for use in a radar chart. In one exemplary embodiment, radar chart data system 208 can generate a user interface prompt for a user to enter a set of data for a radar chart, rows and columns of a spreadsheet for generation of a radar chart, and other suitable data. Likewise, other suitable sets of data can be received or provided in a radar chart data format, such as in a file format, delimited fields in a digital document or in other suitable manners.

Donut chart data system 210 provides and receives data in a format suitable for a donut chart. In one exemplary embodiment, donut chart data system 210 can generate a user interface prompt for a user to enter a set of data for a donut chart, rows and columns of a spreadsheet for generation of a donut chart, and other suitable data. Likewise, other suitable sets of data can be received or provided in a donut chart data format, such as in a file format, delimited fields in a digital document or in other suitable manners.

Bubble chart data system 212 provides and receives data in a format suitable for a bubble chart. In one exemplary embodiment, bubble chart data system 212 can generate a user interface prompt for a user to enter a set of data for a bubble chart, rows and columns of a spreadsheet for generation of a bubble chart, and other suitable data. Likewise, other suitable sets of data can be received or provided in a bubble chart data format, such as in a file format, delimited fields in a digital document or in other suitable manners.

In operation, system 200 provides metrics data in a suitable format, such as for use in analyzing charitable organization performance data, and allows different users to access the data for performing analyses, for sharing and for other suitable purposes.

FIG. 3 is a diagram of a system 300 for providing metrics display functionality in accordance with an exemplary embodiment of the present disclosure. System 300 includes metrics display function system 116 and high/low display system 302, spreadsheet display system 304, pie chart display system 306, radar chart display system 308, donut chart display system 310 and bubble chart display system 312, each of which can be implemented and hardware or suitable combination of hardware and software.

High/low display system 302 generates high/low charts on a user display device. In one exemplary embodiment, high/low display system 302 can receive data sets in a high/low data format and can generate user controls to allow a user to interactively view and modify a high/low display, such as to view user-selected data ranges, user-selected display formats or other suitable data. In another exemplary embodiment, the user can select data sets configured for other uses, such as from a spreadsheet data source, a pie chart data source or other suitable data sources, and can generate high/low displays, can apply one or more selected functions to high/low data or to other data sets to generate high/low data, or can perform other suitable functions to determine whether additional useful data is available. In this manner, existing high/low data sets and other types of data can be analyzed to generate organizational performance metrics.

Spreadsheet display system 304 receives data sets and generates spreadsheet displays based on the data sets. In one exemplary embodiment, spreadsheet display system 304 can receive data sets in a spreadsheet data format and can generate user controls to allow a user to interactively view and modify a spreadsheet display, such as to view user-selected data ranges, user-selected display formats or other suitable data. Spreadsheet-related data charts can also or alternatively be generated, such as bar charts, scatter charts, area charts, line charts, box and whiskers, quartile, tree maps, geographic maps (using, color, heat, bar charts associated with map features), suitable combinations of charts and other suitable charts. In another exemplary embodiment, the user can select data sets configured for other uses, such as from a high/low data source, a pie chart data source or other suitable data sources, and can generate spreadsheet displays, can apply one or more selected functions to spreadsheet data or to other data sets to generate spreadsheet data, or can perform other suitable functions to determine whether additional useful data is available. In this manner, existing spreadsheet data sets and other types of data can be analyzed to generate organizational performance metrics.

Pie chart display system 306 receives data sets and generates pie chart displays place based on the data sets. In one exemplary embodiment, pie chart display system 306 can receive data sets in a pie chart data format and can generate user controls to allow a user to interactively view and modify a pie chart display, such as to view user-selected data ranges, user-selected display formats or other suitable data. In another exemplary embodiment, the user can select data sets configured for other uses, such as from a spreadsheet data source, a high/low data source or other suitable data sources, and can generate pie chart displays, can apply one or more selected functions to pie chart data or to other data sets to generate pie chart data, or can perform other suitable functions to determine whether additional useful data is available. In this manner, existing pie chart data sets and other types of data can be analyzed to generate organizational performance metrics.

Radar chart display system 308 receives data sets and generates radar chart displays as function of the data in the data sets. In one exemplary embodiment, radar chart display system 308 can receive data sets in a radar chart data format and can generate user controls to allow a user to interactively view and modify a radar chart display, such as to view user-selected data ranges, user-selected display formats or other suitable data. In another exemplary embodiment, the user can select data sets configured for other uses, such as from a spreadsheet data source, a pie chart data source or other suitable data sources, and can generate radar chart displays, can apply one or more selected functions to radar chart data or to other data sets to generate radar chart data, or can perform other suitable functions to determine whether additional useful data is available. In this manner, existing radar chart data sets and other types of data can be analyzed to generate organizational performance metrics.

Donut chart display system 310 receives data sets and generates donut chart displays as a function of the data in the data set. In one exemplary embodiment, donut chart display system 310 can receive data sets in a donut chart data format and can generate user controls to allow a user to interactively view and modify a donut chart display, such as to view user-selected data ranges, user-selected display formats or other suitable data. In another exemplary embodiment, the user can select data sets configured for other uses, such as from a spreadsheet data source, a pie chart data source or other suitable data sources, and can generate donut chart displays, can apply one or more selected functions to donut chart data or to other data sets to generate donut chart data, or can perform other suitable functions to determine whether additional useful data is available. In this manner, existing donut chart data sets and other types of data can be analyzed to generate organizational performance metrics.

Bubble chart display system 312 receives data sets generates bubble chart displays as a function of the data in the data sets. In one exemplary embodiment, bubble chart display system 312 can receive data sets in a bubble chart data format and can generate user controls to allow a user to interactively view and modify a bubble chart display, such as to view user-selected data ranges, user-selected display formats or other suitable data. In another exemplary embodiment, the user can select data sets configured for other uses, such as from a spreadsheet data source, a pie chart data source or other suitable data sources, and can generate bubble chart displays, can apply one or more selected functions to bubble chart data or to other data sets to generate bubble chart data, or can perform other suitable functions to determine whether additional useful data is available. In this manner, existing bubble chart data sets and other types of data can be analyzed to generate organizational performance metrics.

In operation, system 300 allows data sets for different types of analytical metrics to be used, modified or otherwise analyzed to generate organizational metrics. System 300 facilitates the analysis of operational data to identify key metrics for comparing organizations and other suitable purposes.

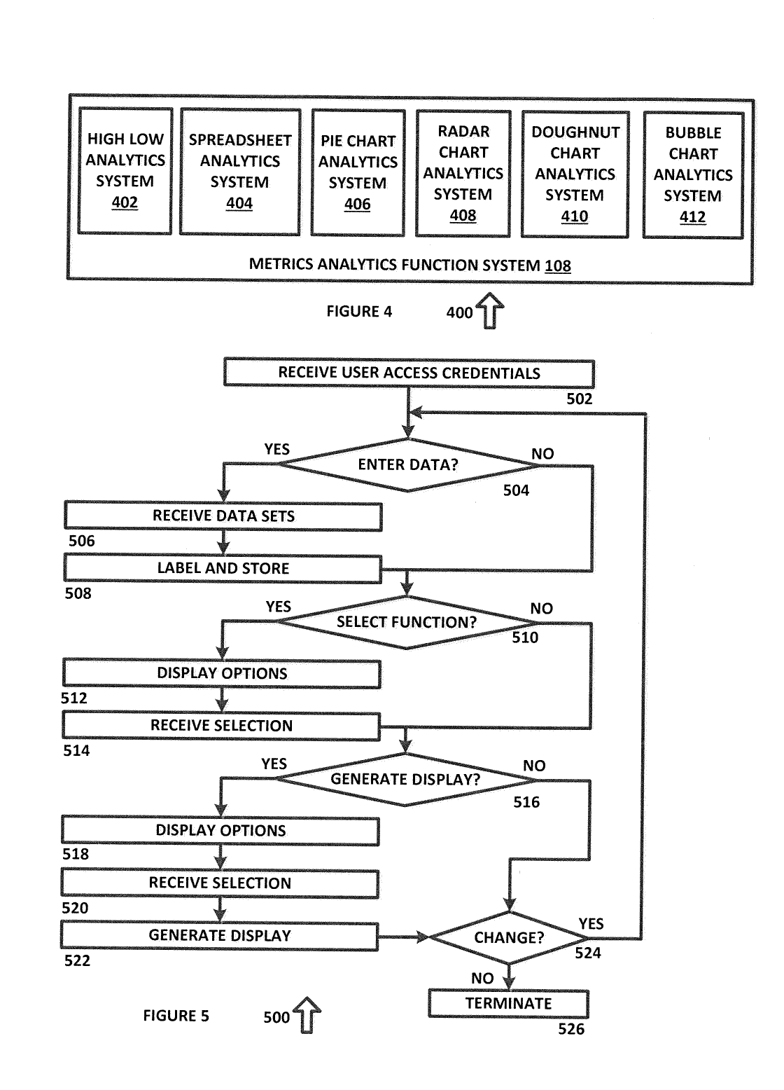

FIG. 4 is a diagram of a system 400 for providing metrics analytics functions capability in accordance with an exemplary embodiment of the present disclosure. System 400 includes metrics analytics function system 108 and high/low analytics system 402, the spreadsheet analytics system 404, pie chart analytics system 406, radar chart analytics system 408, donut chart analytics system 410 and bubble chart analytics system 412, each of which may be implemented in hardware or a suitable combination of hardware and software.

High/low analytics system 402 receives and provides analytic functions for high/low chart analysis. In one exemplary embodiment, a user can receive or provide analytics functions for data, such as data that is in a high/low chart format, data from a spreadsheet that will be analyzed for a high/low chart, data from a pie chart data set that will be analyzed for a high/low chart and so forth. In this exemplary embodiment, the user can determine that a data set that is used for high/low chart analysis can be used with a new function or for a second or alternate chart type or analysis. In this manner, new ways of analyzing and looking at data can be developed.

Spreadsheet analytics system 404 receives and provides analytic functions for spreadsheet chart analysis. In one exemplary embodiment, a user can receive or provide analytics functions for data, such as data that is in a spreadsheet format, data from a high/low chart that will be analyzed with a spreadsheet, such as bar charts, scatter charts, area charts, line charts, box and whiskers, quartile, tree maps, geographic maps, data from a pie chart data set that will be analyzed spread sheet and so forth. In this exemplary embodiment, the user can determine that a data set that is used for spreadsheet analysis can be used with a new function or for a second or alternate chart type or analysis. In this manner, new ways of analyzing and looking at data can be developed.

Pie chart analytics system 406 receives some provides and analytics functions for pie chart analysis. In one exemplary embodiment, a user can receive or provide analytics functions for data, such as data that is in a pie chart format, data from a spreadsheet that will be analyzed for a pie chart, data from a high/low chart data set that will be analyzed for a pie chart and so forth. In this exemplary embodiment, the user can determine that a data set that is used for pie chart analysis can be used with a new function or for a second or alternate chart type or analysis. In this manner, new ways of analyzing and looking at data can be developed.

Radar chart analytics system 408 receives and provides analytics functions for radar chart analysis. In one exemplary embodiment, a user can receive or provide analytics functions for data, such as data that is in a radar chart format, data from a spreadsheet that will be analyzed for a radar chart, data from a pie chart data set that will be analyzed for a radar chart and so forth. In this exemplary embodiment, the user can determine that a data set that is used for radar chart analysis can be used with a new function or for a second or alternate chart type or analysis. In this manner, new ways of analyzing and looking at data can be developed.

Donut chart analytics system 410 receives and provides analytics functions for radar chart analysis. In one exemplary embodiment, a user can receive or provide analytics functions for data, such as data that is in a donut chart format, data from a spreadsheet that will be analyzed for a donut chart, data from a pie chart data set that will be analyzed for a donut chart and so forth. In this exemplary embodiment, the user can determine that a data set that is used for donut chart analysis can be used with a new function or for a second or alternate chart type or analysis. In this manner, new ways of analyzing and looking at data can be developed.

Bubble chart analytics system 412 receives and provides analytics functions for bubble chart analysis. In one exemplary embodiment, a user can receive or provide analytics functions for data, such as data that is in a bubble chart format, data from a spreadsheet that will be analyzed for a bubble chart, data from a pie chart data set that will be analyzed for a bubble chart and so forth. In this exemplary embodiment, the user can determine that a data set that is used for bubble chart analysis can be used with a new function or for a second or alternate chart type or analysis. In this manner, new ways of analyzing and looking at data can be developed.

In operation, system 400 allows functions for different types of analytical metrics to be used, modified or otherwise analyzed to generate organizational metrics. System 400 facilitates the analysis of operational data to identify key metrics for comparing organizations and other suitable purposes.

FIG. 5 is a diagram of an algorithm 500 for providing user access to data sets, displays and data analysis functions, in accordance with an exemplary embodiment of the present disclosure. Algorithm 500 can be implemented in hardware or suitable combination of hardware and software.

Algorithm 500 begins at 502, where user access credentials are received. In one exemplary embodiment, user can be prompted to enter a user ID and other account access controls, and the user's identification can be used to determine the data sets, displays, functions, or other suitable data or functions that a user is permitted to access. The algorithm then proceeds to 504.

At 504 it is determined whether the user has selected and entered a data entry control, such as by selecting a control from a graphic user interface of a display that prompt the user to enter data. If it is determined that the user has not selected to enter data control, the algorithm proceeds to 510, otherwise the algorithm proceeds to 506.

At 506, one or more data sets are received from the user. In one exemplary embodiment, the user can enter data sets in response to prompts, can download a file with predetermined data characteristics, can provide the characteristics for file, can modify a stored data set and save the data such as a new data set, or can provide other suitable date as sets. The algorithm then proceeds to 508.

At 508, the data sets are labeled and stored, such as in a private file for subsequent use by the user, in a public database, or in other suitable manners. The algorithm then proceeds to 510.

At 510, it is determined whether a user has selected a function control, such as by selecting to retrieve or enter functions from a graphic user interface function selection control or in other suitable manners. If it is determined that a function control has not been selected, the algorithm proceeds to 516, otherwise the algorithm proceeds to 512 where options for function selections are displayed. In one exemplary embodiment, the options can include selection of functions class by type of data to be analyzed (such as for pie charts, spreadsheets and so forth), selection of types of data to be analyzed (such as financial data, benefits data and so forth) or other suitable options. The algorithm then proceeds to 514.

At 514, the selected function is received and implemented. In one exemplary embodiment, the selected function can be applied to a data set, the selected function can be modified and stored by the user, or other suitable functions can be implemented. The algorithm then proceeds to 516.

At 516, it is determined whether a user has selected a generate display option from a user interface. If it is determined that the user has not selected the generate display option, the algorithm proceeds to 524, otherwise the algorithm proceeds to 518.

At 518, a user interface control is generated for selecting display options, such as to generate a high/low chart display, a spreadsheet display, a pie chart display, and so forth. In addition, the user can be provided with one or more controls to modify the units of the display, one or more controls to generate a new type of display with the same data, one or more controls to apply a function to the data used for the display, and other suitable functions. The algorithm then proceeds to 520.

At 520, the selected display and functions are received and applied to the selected data, and the algorithm then proceeds to 522, where one or more displays generated using the data set selections, the display options, the functions and other suitable selections. The algorithm then proceeds to 524.

At 524, it is determined whether any changes should be applied to the data set, function, display or other suitable parameters. If it is determined that no changes are to be made, the algorithm proceeds to 526 and terminates, otherwise the algorithm returns to 504.

In operation, algorithm 500 allows users to access data sets, functions, and displays in order to collaborate with other users for the creation of metrics.

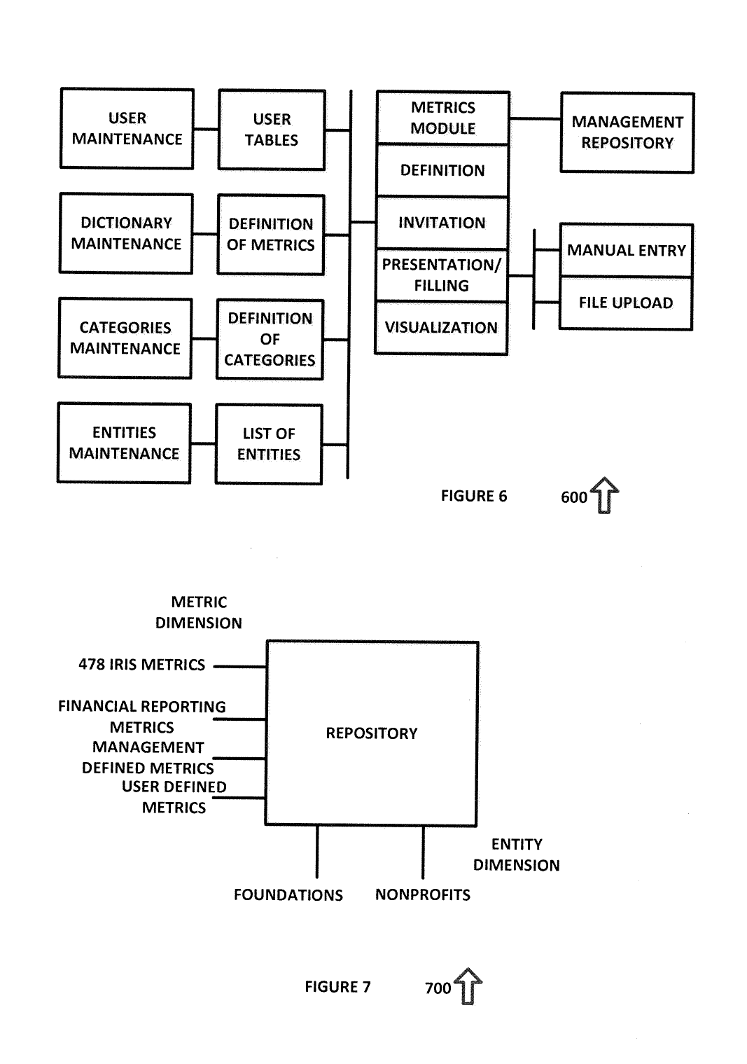

FIG. 6 is a diagram of field metrics 600 with associated system components. A model of the field metrics functionality is shown. Processes on the left create tables (or other suitable database structures) in four categories. These structures are used by the field metric component which is shown broken down into its four sub-components:

Users Component—field metrics can include the implementation of a user account system. User accounts can be secure, using standard web practices. The user component can include functions to create new accounts, manage accounts, and mark an account inactive. A lost password can be restored, a password hint can be requested, and privacy preferences/profiles can be managed without manual assistance.

The user profile can maintain a significant amount of personal information about the user, including an uploaded user picture, a selection of icons, display preferences, name, address, and other contact information. The user profile is self-maintained and friendly.

A user account can be associated with social media accounts, and if they are then social media login can be employed, however, the user account can be self-sufficient without requiring a particular social media provider.

In addition to typical user profile, there can be special requirements for the user component:

A user can record an interest in an entity (Level 0)
A user can be associated with Entities. (Level 1)
A user can be an administrator for an entity (Level 2)
A user can be assigned expert status.
A user can choose default sharing options.

When a user sets up a profile, they can some or all of this information. For special user credentials, the system administrator can set credentials.

Users can be allowed to create a public profile, such as one that includes a name, contact info, entity associations and other suitable data. Users can be allowed to connect through a social media account login (such as Linked In or Facebook). Users can be associated with entities or collections. Users can be authorized for specific entities. User can be allowed to create an entity and can be the administrator for that entity. Users can be identified as experts. Users can enable users to associate their account with an entity. Users can provide secure accounts. User data can be read. Users can be authenticated. Users can be identified and credentialed by the system. Users can be allowed to invite people to create accounts. Users can allow people to create, modify, and delete (mark inactive) their accounts. Users can get credit (attribution) when they load or comment on a metric.

Entities can be the tracked elements in the system. Entities can be organizations identified with a not-for-profit status and in the US can be characterized by their tax status. Entities in the US can file non-profit tax returns, form 990, which is the source of much publically available information. Entities can be government agencies. In addition, the system will use Entities to represent certain geographical regions on which data can be collected as well.

Information is available in the system for each entity. The definition of each piece of information about an entity can be defined in the Dictionary, and referred to as a metric. Static information, such as the street address of an entity, can be considered a metric, and the requirements of a street address can be defined in the Dictionary. Entities can allow the creation of groups, such as funded non-profits. Entities can have a single point of contact or administrator. Entities can have an authorized user to confirm relationships to other users. Entities can allow levels of access for users to modify metrics for the entity. The system can load the initial list of entities.

Relations between entities, such as ownership or control, can be provided. Other relations, such as applying for or receiving a grant can be provided. Entities can exist separately in the entity table, and be linked by a relations structure. Entities can be sub-entities of others and will be relations, such as a church operating a soup kitchen.

Grants can be a form of relations between entities. Government agencies can be considered entities, where they are similar to foundations.

FIG. 7 is a diagram showing two dimensions of a multidimensional repository, namely, metrics and entities.

Categories can be used to classify kinds of social good. In the system, categories are labels and many categories can be manually or automatically associated with entities. The system can adopt the categories available in NTEE codes, can also or alternatively allow users to extend categories in much the same way as a user can extend the metrics definitions, and can perform other suitable functions. A list of NTEE-CC codes at the NCCS can be adopted, and the system can extend these codes as needed.

A user interface can be provided to choose categories. The user interface can allow searching and present a description of each code. It can be possible to select multiple codes. Categories can be based on NTEE/NPC codes, can define kinds of social good, can be labels and not a hierarchy, or can provide other suitable functions.

Field metrics can include a dictionary component. The dictionary can be used to define metrics. More generally, the dictionary can be a data dictionary that defines every “field” known about an “Entity” in the system repository. As such the Dictionary is an extremely important part of the system architecture.

In general, the dictionary can be maintained by the system. Using IRIS data as an initial source, the dictionary can be populated with standard metrics for non-profits. These can include financial metrics that are associated with such entities. In addition, the system can extend the metrics as needed and use the dictionary to record all kinds of information about an entity that might not be considered metrics.

User interfaces can be provided which allow both internal users and customer users to search, view, and maintain metric definitions in the dictionary. The dictionary can contain IRIS information about a metric, including name, description, citations, user guidance and so forth. It can also contain information about metric utilization so that popular metrics can be identified. Users can “favorite” metrics.

Metrics can also be assigned and searched on category labels. Metrics that are particularly applicable to particular categories can be identified with labels, so that a metric related to health, or more detailed category such as childhood obesity can be located easily. The dictionary can include local data for specific customers, can consist of a global data dictionary to support metric attributes.

The field metrics module can be a subset of the metrics functionality. Field metrics can include the ability for the users to create and answer metrics surveys that can supplement publically collected and system-created metrics in describing an entity. Field Metrics component can be broken down into four subcomponents or phases. The phases can represent the workflow that defines the process of defining and obtaining the metric. Exemplary phases are Definition, Invitation, Presentation/Filling and Visualization.

During the Definition phase, a user can define a field metric. Field metrics can be composed of a series of questions. Each question in a field metric can be chosen from the dictionary. The dictionary can contain all the metrics and all the information stored with each metric (See dictionary section above). The user can be given the chance to modify the default wording of the question, and order questions according to their desires. In addition, the user can add textual material to explain the purpose and use of the field metric to other users.

Lists of questions that make up field metrics can be saved so that a field metric can be easily reused or added to, and the authors are identified and attributed, along with their organizational affiliation.

It is possible that in the definition of a field metric, the user will discover the need to add an additional metric to the dictionary. The user interface can interrupt the definition process, and go to the metric maintenance function so that a new metric can be added. Following this process, the user can resume the definition of the field metric, using the newly entered metric.

A field metric can be a survey, while a metric can be a question that makes up the survey. Since all the metrics can be in the dictionary, the process of constructing the survey can be fast and appealing. There can be enough information in each metric definition in the dictionary so that by default the question text and the standard data entry widgets are selected.

An appropriate data entry widget can exist for each data type that can be used in a metric. For example, if the metric requires a YES/NO answer, a widget designed to simply enter that information (radio buttons) can be the default and automatically selected. For more complex data types, there can be a choice of multiple entry widgets.

Each widget can have a common look and feel and standard information. There can a reference to the metric identification, a control that retrieves the definition of the metric from the dictionary, information on the last time the metric definition was updated, and other suitable data. Visibility at the widget level of the previous answers to this current question can be provided, which can allow the user to see previous answers, such as in the case of a periodic Field Metric survey.

The system can present the same survey for subsequent periods. The system can accept more granular time series data for any time defined metric, and can accumulate results into different units of measurement in the time domain. This conversion can take place at the point that metrics are gathered in the presentation subcomponent, and can be based on information obtained in the definition subcomponent.

Information provided at definition can include the author of the field metric, that person's entity affiliation, creation and access timestamps, and the requirements for signatures and privacy associated with the field metric. Each field metric can have a period assigned: one time, one request, or various time periods (daily, weekly, monthly, semimonthly, bimonthly, quarterly, yearly and so forth).

A metric can be associated with an entity. When filling a field metric, the entity that the user is answering for can be required. Where a user has multiple affiliations, this can mean selecting the entity before a field metric survey is completed. The system can use the field metric functionality to ask for and obtain information about the users themselves, in which case the entity is the user.

Once a field metric is defined, it can be stored in a library of surveys. The library can allow re-use of field metrics that can enable comparability between time periods, or across organizations. The user can select field metrics and invite other users to respond to them. The invitation process can involve selecting users to respond to the field metric, and make a request to those users either my email reminder or on their next log-in, or both. Users can be chosen from the user database, through a variety of selection criteria, or in other suitable manners.

Select particular user by name.
Select a single user affiliated with a particular entity.
Select a group or all the users affiliated with an entity.
Select a single user from each of a collection of entities.
Select all users from a collection of entities.
Any other reasonable selection criteria for users (a geographical range for instance).

The invitation sent to the users can be attributed to the person and the entity which invites them. There can be a specified period and expiration date for each invitation. Each field metric can be defined for a specific period, so repeating invitations can be scheduled at the same period, and automatic invitations can be created.

A user can also or alternatively complete a field metric by choosing it from a field metric browser and filling in an associated form.

In order to invite a user to fill in a field metric form, the user and the entity can be selected. The user can be selected as above, and the entity can be specified by the Inviter. For example, if “Bob Jones” is asked to do a field metric for “Red Cross of San Diego” he does not require a specific relationship to Red Cross, however if he has one, that status can be included in the metric.

Since an invitation can involve requesting a user to complete a series of questions about an entity, and because a metric can be a measure about an entity for a period, the field metric can be associated with a specific period. Inviting can include the definition of the period and the entity for which the user is requested to answer.

The system can support periodic requests for field metrics in the invitation module. The invitation functions can permit setting up a repetitive invitation based on some standard periods, and can allow scheduled release of invitations on specified dates and times.

The invitation module can be able to keep track of the status of invitations (in terms of the Users invited and whether they have completed the field metric), and also the planning of recurring invitations. Users who have invited others can cancel those invitations not yet sent. The invitation module can offer the options of sending an email to the user asking them to complete the field metric, reminding the user shortly before the deadline, not sending any email at all, or other suitable options.

Once a field metric is defined and users have been invited, the questions on the metric can be presented to the user and filled-in to complete the entry of the field metric.

The user can answer predefined metrics in each of the questions, but can also be able to supply supporting material, go into more detail, decline to answer, or perform other suitable functions. Since each metric that makes up the survey (field metric) can be a choice from the thousands of possible questions in the dictionary, and each dictionary entry can specify a data type, a default question, visualization, and query format, the number of possible field metrics can be large, and the ways of presenting the request can be large.

The system can supply widgets for collection and entry of standard data types. There can be standard information in each widget, regardless of function, such as link to the dictionary definition of the metric, add supporting material, review previous answers to the same question, or other suitable functions. In addition, the data type can define the look and the user interface for the widget. In one exemplary embodiment, widgets to perform the following functions can be provided:

1. Binary YES/NO choice in the form of radio buttons where only one button can be selected at a time.
2. Slider returning a range response, such as to rate a criterion on the scale of 1 to 5.
3. Text input.
4. File upload input and request an attachment.
5. Array input
6. Matrix input

There can be a default input method associated with each metric in the Dictionary, which the user can override. The metric chosen can load some basic text automatically, which the user can update, for example to change the wording of a question or to add details. The widgets can have a standard format, even as the data type and questions change. The widget can show the metric (or metrics in some cases) that is being reported. A user-activated control can be provided for a pop over window that contains all the information about the metric. A metric entry screen can be provided in the user interface to show the material available. The user can also be able to select “past answers” and a pop over window can be generated showing previous answers to the question which are displayed using the default visualization type. In this way, the user can assure that date entered is consistent with previous runs of the same field metric for prior periods.

An “attach details” control can be provided to allow a user to add more explanation or a supporting attachment. The user can answer the question as written, can “tunnel down” to more details in the user's own format, or can perform other suitable functions.

The system can include elaborate visualizations of suitable metrics through an insight portal and metrics functionality. The user can be enabled to see a single field metric for an entity, a composite of field metrics for a collection of entities, a collection of field metrics for a collection of entities or other suitable data. Metrics can include an individual metric from a dictionary to create a question list, can include preparing, inviting, presenting/filling, display & visualization, can have different types of responses (data types), can be categorized into known formats and categories, can guess and confirm user metrics choices and match with existing metrics, can correlate metrics under same category, can allow favorite metrics based on type of metric, category, entity, can consist of an organized list of metrics from the dictionary, can provide an interface to clean up from bad actors, can allow most used metrics to be marked favorite by users, can allow users to share content, can credit authors of content, can validate data, can check for inaccuracies, can be displayed until superseded (need a data retention policy), can be retained indefinitely, can be maintained for a period of time, can have a survey as a collection of metrics, can offer a series of questions for a user to answer, can enable export to an *.xls or flat file, can allow supporting material upload, can allows user to augment collected metrics with more granularity of detail, can allow user to edit a metric they posted, subject to authorization, can protect personally identifiable information and other data as requested, can accept batch files, can visualize data according to the default type for the metric, can allow users to set permissions for the reuse of data, can be measurements over a defined period, can enable users to manually input their metrics directly into a table displayed in the browser and can perform other suitable functions.

In one exemplary embodiment of a landing page, a user can log in and press a metrics control on the graphic user interface. A red highlighted number can be used to show that there are pending surveys for this user to address. When surveys exist, a banner can appear at the top of the “My Metrics” page showing the metrics that need to be filled. The user can click on either metric in the metric form alerts box to begin the process.

In another example for a metrics entry form, the user can be presented with a simple and clean user interface and can scroll down the necessary number of questions. Fields that need to be entered can be highlighted. The dictionary definition of a metric can be reviewed, and supplementary attachments can be added for each question as needed. The system can also provide the ability to view previous answers to each question, where they exist. At the end of the form entry, the user can sign the form and submit the metric. The inviting user (and entity) and the responding user (and their associated entity) can be shown at the top of the screen, along with a progress bar.

In a metrics selection screen, an example of the process of building a field metric form includes browsing the metric dictionary. A simple and reactive process of narrowing the possible choices of metrics can be provided by selecting and entering information in the fields at the top. As the selection is narrowed, the upper box can show possible matching metrics from the dictionary. When the user actuates a selection control, the metric can be copied to a “my selections” box at the bottom, which can be sorted in a desired order. The user can edit the metric to change the wording of the questions, can accept the default or can perform other suitable functions. Once complete, the user can actuate a control that creates the field metric form and adds it to a library of forms. Users can then be invited to complete the metric.

The dictionary can allow multiple tags of each metric. Metrics can be assigned to categories. Everything tracked and comparable in the system can be stored in the dictionary. The dictionary can define each metric. The dictionary can import IRIS metrics definition (subject to license). The dictionary can include all info about a metric, can allow users to add and maintain metrics and users can upload a metric that has never been tracked in the system before. Field metrics can allow for unit conversion of metrics. A mobile application can be provided that allows entry of metrics in real time, field metrics can be shared with individuals, organizations (or group of organizations such as grantees), and separately can be made viewable by the public as a whole, can create surveys/questionnaires that are sent to specific users or are open to the public to reuse. Field metrics can visualize the metrics automatically according to a set of patterns/type and size of data set, can function to flag metrics for moderator to review, a moderator can be provided, field metrics can have “pages” based around areas of focus and geography (pre-made and custom dashboards), users can be allowed to compare results of a survey/template that multiple organizations filled out (one to many). Entities can require an EIN (or equivalent) to be created, can be verified. Metrics can function to consolidate metrics in single data-sets, Ability to share metrics, including “mix and match” of ecosystems (who can see what portion of metrics/survey responses, collecting meta data about a metric, such as population, geographic area, cause/issue, etc. by allowing the user to choose from taxonomy or manually enter.

Metrics can include search fields and descriptive (meta, open) fields that can have descriptive fields, can have predictive/suggested text (as the user starts typing, a drop-down will show terms/existing entries that match or relate to the one being typed). A user can find metrics that are relevant to a subject area. Field metrics can allow the user to input their metrics in their preferred unit and the system can translate the units as needed. Metrics can allow for peer review of metrics (workflow or collective rank). The system can generate suggestions to the user of an existing metric that matches or resembles the one that the user is trying to upload (in order to avoid duplications and help with comparability/analysis of metrics). Metrics can have an associated popularity/ranking function, to identify metrics that have been “liked” more than others, metrics can have any suitable data type, such as a number, alphanumeric string, array, Boolean, multiple choice and so forth. Comments on data sets can be facilitated. Integration with grant management systems can be provided, such as by allowing a user to import metrics data that can be stored there, by sending out surveys/templates to grantees from their systems or in other suitable manners. Peer review can be attributed. Users can invite others to post or view metrics. Users can have a user profile. Users can be able to link their profile to social media. Users can be associated with groups (circles).

Case 1: Normal, Repetitive Use by a reporting Non-Profit Entity. A specific user who is the authorized User for an Entity is requested by a funding source to please report for the current period.

1. User goes to system
2. User credentials are already stored in the computer (cookies), no login is required.
3. User immediately lands on system home page, which shows relevant information from an insight portal related to an associated entity, interests, and previous selections.
4. User notes that the metric icon at the top of the screen can have a red (1) next to it indicating that there is one requested field metric for this user.
5. The user can actuate a metric control.
6. The user can be directed to a metric homepage. If no field metric was requested, the user can be presented with an interface with an associated entity displayed. Because a field metric is requested, in a special sub-window at the top of the page, data can be generated including a name of the field metric, a requesting user, a requesting entity, a period for the metric, a deadline and other suitable data.
7. The user can actuate a “Start” control and be presented with a fillable form for the field metric. The user can answer questions with one click and types or attach information as needed.
8. User completes form, seeing a progress bar. User is not required to fill in all answers. User can see previous answers to each question by clicking the icon on the question.
9. User can suspend the form, “Save as Draft”, at any stage and will return to step 6 on return. Step 6 changes to “Return to this Field Metric” instead of “Start this Field Metric”.
10. When User reaches the bottom of the form, a privacy option and a signature location can be provided. User can choose how to share (public, with logged-in users, with requesting entity) for example, and electronically signs the metric.
11. System returns the user to the metric page. A red number on icon can be updated to show the field metric is completed.

Case 2: Invited by new user. Using an invitation functionality in field metrics, a new user known only by an email address is invited to complete a field metric.

1. A field metrics invitation component can send an email to the user with a standard template. The mail can contain a link (URL) with a hashed code so the new user can be tied to the invitation.
2. User clicks link.
3. User lands on a welcome page and is asked to set up a new account.
4. User chooses username, password and can optionally fill out profile information. User chooses an entity affiliation.
5. User is successfully logged in. Email verification not needed because already have it from the invitation. User gets usual welcome email as a new user.
6. User lands on the system home page.

### 7. Go to Step 4 in Case 1.

Case 3: Foundation sets up a recurring new survey. A user works for a foundation and wants to create a field metric survey to be filled in by a list of grantees every four weeks.

1. The user logs-in and goes to their default view of the system, such as the insight portal for the foundation.
2. The user can actuate a metric control from a top menu.
3. The user can see a metric control screen in their default view.
4. The user can actuate a metric menu and select a create option.
5. System displays the browser for the library of surveys. This is similar to the metric browser, showing a selection criteria, and a live list of the most popular surveys meeting the selection criteria. User can browse by category to see surveys related to a class of charitable giving and can narrow the selection by typing keywords.
6. User does not find an existing survey which is satisfactory so decides to create a new one by actuating a new survey control at the bottom of the screen. The user is presented with a confirmation control before advancing to next page.
7. User selects and modifies metrics using the metric browser. User builds a list of metrics and selects their order using the up/down buttons on the metric browser.
8. User decides to modify the question shown in one metric, changing the wording with ab edit control on the metric browser.
9. User completes the survey by pressing the DONE button. User is asked to name the survey.
10. User lands back on the Survey Library page, current selected survey in the one just named and completed.
11. The user can fill out the survey themselves from this page, or can invite users with a control that is located at the bottom of the page.
12. Top of invite page has a section called find users and Invite by email.
13. Find users shows most recent users first.
14. By typing in a criteria box, selection is narrowed.
15. There is also a search by entity for affiliated users.
16. Recurring options are shown and selected standard options include Weekly, Monthly, Quarterly, Annually. User selects Monthly.
17. Two or three users are selected and invited. User presses INVITE button at bottom of screen.
18. INVITE screen shows pending invitations for selected users, and recurrence options.

### 19. Go to Step 4 in Case 1.

It can be emphasized that the above-described embodiments are merely examples of possible implementations. Many variations and modifications can be made to the above-described embodiments without departing from the principles of the present disclosure. All such modifications and variations are intended to be included herein within the scope of this disclosure and protected by the following claims.

What is claimed is:

1. A system for analyzing data, comprising:
a metrics data system operating on a processor and configured to generate a user prompt that allows a user to interactively provide metrics data associated with an organization;
a metrics display function system operating on the processor and configured to generate a user prompt that allows a user to interactively select or modify a display process that is to be applied to the metrics data; and
a metrics analytics function system operating on the processor and configured to generate a user prompt that allows a user to interactively select or modify a data analysis function that is to be applied to the metrics data.

2. The system of claim 1 further comprising a spreadsheet data system configured to generate a user prompt that allows a user to interactively provide spreadsheet data associated with an organization.

3. The system of claim 1 further comprising:
a spreadsheet data system configured to generate a user prompt that allows a user to interactively provide spreadsheet data associated with an organization; and
a bar chart data system configured to generate a user prompt that allows a user to interactively provide bar chart data associated with an organization.

4. The system of claim 1 further comprising:
a spreadsheet data system configured to generate a user prompt that allows a user to interactively provide spreadsheet data associated with an organization; and
a map data system configured to generate a user prompt that allows a user to interactively provide map data associated with an organization.

5. The system of claim 1 further comprising:
a spreadsheet data system configured to generate a user prompt that allows a user to interactively provide spreadsheet data associated with an organization; and
a scatter chart data system configured to generate a user prompt that allows a user to interactively provide scatter chart data associated with an organization.

6. The system of claim 1 further comprising:
a spreadsheet data system configured to generate a user prompt that allows a user to interactively provide spreadsheet data associated with an organization; and
an area chart data system configured to generate a user prompt that allows a user to interactively provide area chart data associated with an organization.

7. The system of claim 1 further comprising:
a spreadsheet data system configured to generate a user prompt that allows a user to interactively provide spreadsheet data associated with an organization; and
a line chart data system configured to generate a user prompt that allows a user to interactively provide line chart data associated with an organization.
